(19) United States
(12) Patent Application Publication
(10) Pub. No.: US 2022/0318867 A1
(43) Pub. Date: Oct. 6, 2022

(54) LOTTERY TICKET SHARE SALES SYSTEM USING INTERNET

(71) Applicant: Sang Hyun NAM, Namyangju-si (KR)

(72) Inventor: Sang Hyun NAM, Namyangju-si (KR)

(21) Appl. No.: 17/607,925

(22) PCT Filed: Mar. 5, 2020
(86) PCT No.: PCT/KR2020/003119

§ 371 Date: Nov. 1, 2021

(30) Foreign Application Priority Data
Apr. 30, 2019 (KR) 10-2019-0050460

(51) Int. Cl. G06Q 30/06; G06Q 50/34; G07F 17/32

(52) U.S. Cl. CPC G06Q 30/0605; G06Q 50/34; G07F 17/329

(57) ABSTRACT

A lotto ticket shares selling system using Internet is disclosed. The server of the lotto ticket shares selling system includes a selling information management unit configured to transmit selling information including lotto selection information consisting of numbered lotto designated by a seller or a purchaser and unnumbered lotto and shares selection information divided for each selected lotto to the purchaser terminal, a purchase information management unit configured to receive purchase information including lotto purchase information and shares purchase information selected by a purchaser with respect to the selling information from the plurality of purchaser terminals, a lotto management unit configured to selectively combine a plurality of lottos included in the purchase information, and match the actual lotto according to a result of summing the combined plurality of lotto shares, and a winning management unit configured to transmit lotto lottery result information and winning money information according to the corresponding shares of the won lotto to the plurality of purchaser terminals.

### TECHNICAL FIELD

The present invention relates to lotto ticket selling, and more particularly, to a lotto ticket shares selling system for dividing and selling lotto ticket shares.

### BACKGROUND ART

Currently, lotto tickets sold on the market are sold offline through a seller's terminal connected to a central computer center equipped with a lotto issuance system and an information and communications network, or are sold online through the purchaser's terminal connected only to the lotto generating system and information communication.

A lotto ticket may be purchased by directly selecting some of the predetermined numbers or by being given a random number. For the purchased lotto tickets, the winning number is determined through lotto on a set date, and winning money is provided to the lotto holder of the winning number.

In Korea's lotto ticket, the purchaser may select 6 numbers out of 45, and the number of numbers that the purchaser may select is different from the predetermined number of numbers for each country.

In general, there is no limit on the amount of lotto tickets sold, and the amount of winning money for the first prize varies according to the amount of lotto sold.

However, the lotto ticket has a very low winning probability, and in order to increase the winning probability, the purchaser has to purchase a large number of lotto tickets, so it takes a lot of money.

In order to solve this problem, as a method to increase the winning probability by purchasing lotto tickets together, there are Korean Patent Publications No. 10-2001-0103082 (lotto trading method of investment betting method for pre-purchased lotto tickets), No. 10-2003-0003154 (Method of jointly owning lotto tickets on the Internet); and No. 10-2004-0091286 (Co-investment and distribution method of lotto and online system accordingly), and the like.

Conventional patents consist of a method of jointly purchasing multiple lotto tickets or a method of purchasing a lotto ticket by creating a fund, so that from the point of view of the purchaser, there was a problem that the degree of freedom in selecting the number of lotto tickets and the quantity to be purchased was low.

On the other hand, the selling price per lotto ticket is determined, it is impossible to purchase lotto tickets with an amount below the selling price per sheet, so there are restrictions on selling lotto tickets.

In addition, many of the purchasers who purchase lotto tickets in large quantities are business operators who use lotto tickets as promotional materials. However, since the selling price per lotto ticket is determined, there are restrictions on using it as a promotional item.

### DISCLOSURE OF THE INVENTION

### Technical Problem

The purpose of the present invention is to provide a lotto ticket shares selling system that allows the purchaser to freely select a lotto number while also allowing the purchaser to purchase a lotto ticket with an amount below the selling price in order to solve the problems of the prior art.

### Technical Solution

A lotto ticket shares selling system of the present invention for solving the above problems in which a server is connected to a plurality of purchaser terminals and information and communications networks that purchase divided shares of lotto, and a seller pays winning money of the lotto to a purchaser according to the shares,

wherein the server includes:

a selling information management unit configured to transmit selling information including lotto selection information consisting of numbered lotto designated by a seller or a purchaser and unnumbered lotto and shares selection information divided for each selected lotto to the purchaser terminal;

a purchase information management unit configured to receive purchase information including lotto purchase information and shares purchase information selected by a purchaser with respect to the selling information from the plurality of purchaser terminals;

a lotto management unit configured to selectively combine a plurality of lottos included in the purchase information, and match the actual lotto according to a result of summing the combined plurality of lotto shares; and

a winning management unit configured to transmit lotto lottery result information and winning money information according to the corresponding shares of the won lotto to the plurality of purchaser terminals.

Preferably, if the lotto purchase information is a lotto designated by a purchaser among the numbered lottos, a purchase-possible minimum share rate is limited in the shares purchase information.

Preferably, the lotto management unit matches the actual lotto by summing shares for each lotto of the same number among the numbered lottos, wherein the remaining shares of the numbered lotto that do not match the actual lotto are added to the shares of the non-numbered lotto or are added to the shares purchased by a seller to match other actual lotto.

Preferably, the remaining shares of the numbered lotto that do not match the actual lotto are combined with the shares of the non-numbered lotto to match other actual lotto, and the remaining shares that do not match the other actual lotto are added to the shares purchased by a seller and matched with another actual lotto according to a result of the summation.

Preferably, if the shares of the non-numbered lotto are 2 or more, the two or more shares are summed with the shares of the numbered lotto in the order in which the remaining number of shares is small or large.

Preferably, if the shares of the non-numbered lotto are or more, each of the 2 or more shares is sequentially summed with the shares of the numbered lottos consisting of different numbers.

Preferably, among the non-numbered lottos, the remaining shares of the non-numbered lotto that do not match the other actual lotto are added to the shares of different non-numbered lottos or combined with the shares purchased by a seller to match another actual lotto.

Preferably, after the purchaser's lotto purchase, until a set time before the lottery, the lotto management unit transmits actual lotto information including serial number of the actual lotto matching each of the numbered lotto and the non-numbered lotto to the purchaser terminal.

Preferably, the purchase information management unit further receives repeat purchase information for purchasing lotto of the next round from the purchaser terminal under the same conditions as the purchase information.

### Advantageous Effects

According to the lotto ticket shares selling system of the present invention, there are the following effects.

The purchaser may purchase lotto shares at a price below the selling price of lotto tickets, so that it is possible to purchase multiple lotto tickets at the same cost, increasing the winning probability.

From the seller's point of view, there are advantages that the present invention significantly may reduce the burden of the initial lotto purchase cost for lotto ticket selling, and may be provided to consumers for promotional purposes by using lotto shares at a price lower than the selling price of lotto tickets.

### BRIEF DESCRIPTION OF THE DRAWINGS

FIG. 1 is a block diagram of a lotto ticket shares selling system according to the present invention.

FIGS. 2 to 4 are diagrams showing matching methods 1 to 3 of numbered lotto and non-numbered lotto.

FIG. 5 is a flowchart showing the order of selling lotto ticket shares according to the present invention.

### MODE FOR CARRYING OUT THE INVENTION

Hereinafter, specific embodiments of the present invention will be described with reference to the drawings.

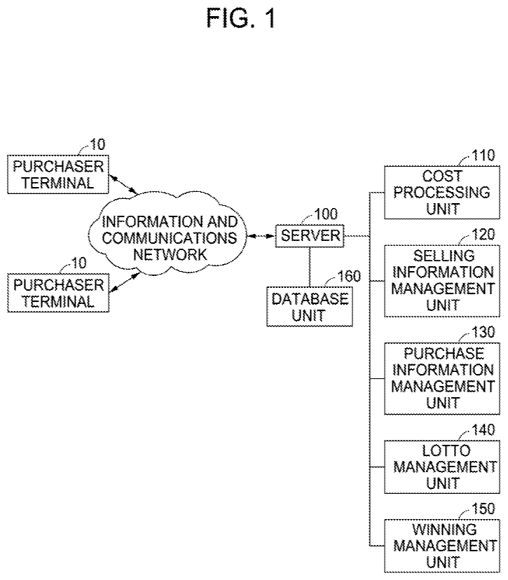

The lotto ticket shares selling system of the present invention is configured by connecting a plurality of purchaser terminals 10 and a seller's server 100 to the information and communications network 20 as shown in FIG. 1. Here, the purchaser terminal 10 is a terminal of a person who wants to purchase a lotto ticket, and includes a personal computer, a mobile terminal, a smart terminal, and the like.

The purchaser uses the purchaser terminal 10 connected to the information and communications network 20 to access the seller's server 100 and undergoes a membership registration procedure and identity authentication. The purchaser transfers a deposit of more than the minimum amount for the purchase of lotto shares to the seller's account, and the transferred deposit information and the purchaser's information (smartphone number, winning money deposit account, etc.) are stored in the database unit 160. As shown in FIG. 1, the components of the seller server 100 (hereinafter referred to as ‘server’) are largely include a cost processing unit 110, a selling information management unit 120, a purchase information management unit 130, a lotto management unit 140, a winning management unit 150 and a database unit 160 for storing information transmitted and received from each component.

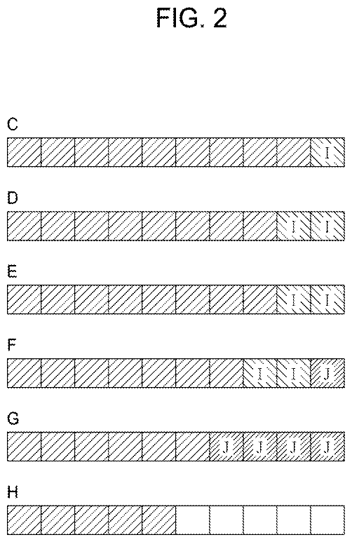

Hereinafter, each component will be described in detail with reference to FIG. 2.

The cost processing unit 110 deducts the purchaser's lotto purchase cost within the range of the deposit provided to the seller by the purchaser, and updates the deposit information by adding winning money according to the lotto winning.

In addition to the deposit for purchasing lotto ticket shares, the seller may charge an annual fee or monthly membership fee to the purchaser, or charge a small fee each time lotto ticket shares are purchased, and all of these deposit, annual fee, monthly membership fee, and fee information is stored in the database unit 160.

On the other hand, the seller may receive a certain amount of money from an affiliate and issue a lotto coupon corresponding to a certain amount of money at a discounted price, or pay additional lotto coupons when purchasing more than a certain amount of money. Here, ‘lotto coupon’ means a coupon that may purchase lotto tickets, and affiliates may distribute coupons to consumers for the purpose of corporate promotion or promotion. Consumers with lotto coupons may use the amount corresponding to the coupons to purchase the lotto.

The seller information management unit 120 transmits selling information to the purchaser terminal 10. Here, the selling information consists of ‘lotto selection information’ and ‘shares selection information’ of undrawn rounds.

The lotto selection information is divided into numbered lotto and non-numbered lotto according to the combination method of lotto numbers that the purchaser may select.

A numbered lotto means a lotto in which a seller or purchaser assigns all or part of a number.

A numbered lotto, where the seller assigns a number, is a lotto in which the seller proposes all or part of a number to the purchaser. The seller may provide the proposed number the same every week or change it at regular intervals.

In the numbered lotto that the purchaser designates a number, the purchaser may randomly select all of the numbers and designate them, or select all or part of the numbers using a random function program.

In the case of lotto that designates part of a number among numbered lottos, the seller or purchaser may specify only 4 out of 6 lotto numbers, and select the remaining two numbers from among other numbers that do not overlap with the four designated numbers using a random function program.

A non-numbered lotto is a lotto in which the entire number is not designated at the time of purchase, but a number is assigned before the lotto after purchase.

The number of non-numbered lotto may be arbitrarily assigned at a specific time before the lotto. Alternatively, a number may be assigned later by converting a non-numbered lotto to a numbered lotto at a specific time before the lotto number draw. A method of converting non-numbered lotto to numbered lotto will be described in detail in the lotto management unit to be described later.

The shares selection information is information on the number of shares that the purchaser may apply for purchase for the lotto corresponding to the lotto selection information (at least one of numbered lotto and non-numbered lotto) selected by the purchaser.

For example, if the selling price of a lotto ticket is 1,000 won, it may be divided equally by 100 won, which corresponds to 10% of the actual lotto or shares, to constitute a total of 10 shares. Therefore, the purchaser may purchase 1 share for each of 10 lotto tickets with different numbers at the cost of purchasing one actual lotto ticket. As a result, the lotto ticket shares purchaser may lower the lotto purchase cost or increase the winning probability.

If the lotto purchase information is a lotto number designated by the purchaser among the numbered lottos, the share purchase information may limit the minimum share rate that may be purchased.

For example, for a numbered lotto that the purchaser designates, the minimum number of shares that the purchaser may purchase may be limited to three.

This is because, if only some of the numbered lotto shares are purchased and the number of lottos for which the remaining shares are un-purchased increases, the seller's burden of purchasing lotto tickets may increase.

In contrast, non-numbered lotto may be converted to numbered lotto with remaining shares, so there is no need to limit the number of shares purchased.

The purchase information management unit 130 receives the purchase information from the purchaser terminal 10, and the cost processing unit 110 updates the deposit information by deducting the lotto purchase cost from the deposit. Here, ‘purchase information’ consists of lotto purchase information and shares purchase information selected by the purchaser with respect to the aforementioned selling information.

The lotto purchase information is information on the lotto that the purchaser applies for purchase within the deposit range, and is at least one selected from numbered lotto and non-numbered lotto.

The shares purchase information is the shares of the lotto purchased by the purchaser.

For example, as a case where the number of shares of one numbered lotto (3, 21, 24, 38, 42, 44) (par value of 1,000 won) is 10 (price of 100 won per share), a case in which three people jointly purchase lotto of the same number is explained with the table below. Hereinafter, it will be described based on the lotto configured in this way.

TABLE 1
Changes in deposits due to purchase of numbered lotto shares

| | | | Shares | |
|---|---|---|---|---|
| | First | Lotto purchase | purchase | Deposit |
| Purchaser | deposit | information | information | update |
| A | 3,000 won | Numbered lotto | 5 | 2,500 won |
| B | 2,000 won | (3, 21, 24, 38, 42, 44) | 3 | 1,700 won |
| C | 5,000 won | | 2 | 4,800 won |
| D | 4,000 won | | 4 | 3,600 won |

According to Table 1, the purchasers who purchased the numbered lotto of the same number are A, B, C, and D, and upon purchase, each initial deposit is deducted and updated according to the purchase information of shares.

Since the seller must pay the winning money to all purchasers when the lotto wins, even if the total number of purchased shares is 14, the seller must secure 2 actual lottos corresponding to the number of shares of 20.

On the other hand, the seller's fee for the purchase of shares may change according to the laws of the relevant country or the seller's policies, and if the seller receives an annual or monthly membership fee, it is possible to proceed without a separate fee.

The lotto management unit 150 selectively combines a plurality of lottos included in the purchase information received from the plurality of purchaser terminals 10, and matches the actual lotto according to the result of summing the shares of multiple lottos combined.

Here, the ‘actual lotto’ is an actual lotto with no shares divided, and may consist of a paper ticket printed from a lottery ticketing machine at a lotto ticket selling office, or may consist of an online electronic signal.

If the actual lotto consists of tickets, the seller must secure and keep the actual lotto ticket before the actual lotto lottery date. When the actual lotto ticket amount is large, it is difficult to manage the won tickets, so that the lotto management unit 150 must map and manage lotto number information, issue number information, and storage location information of the ticket secured by the purchaser.

Hereinafter, a method of the lotto management unit 150 to match the lotto purchased by a plurality of purchasers with the actual lotto will be described.

First, among numbered lottos, shares are summed for each lotto of the same number and matched with the actual lotto. Specifically, by adding up shares for each lotto of the same number for multiple purchasers, 100% of the added shares are matched one-to-one with the actual lotto.

For example, for purchase information of purchasers A, B, C, and D as shown in Table 2 below, the numbered lottos of A and B consisting of the same number are matched with the actual lotto by adding 6 and 4 shares respectively, and the numbered lotto of C and D consisting of different numbers remain unmatched with the actual lotto. In this case, the method of forming the group (A, B) that jointly owns the actual lotto may use a method of giving priority to the summation as the number of purchased shares increases in addition to following the order in which the purchase information management unit 140 receives the purchase information as shown in Table 2.

TABLE 2
Example of summing shares of numbered lotto

| | | | Shares | Remaining |
|---|---|---|---|---|
| | | | purchase | unmatched |
| Purchaser | Lotto purchase information | | information | shares |
| A | Numbered | 3, 21, 24, 38, 42, | 6 | 0 |
| B | lotto | 44 | 4 | 0 |
| C | | | 9 | 9 |
| D | | 7, 13, 15, 22, 30, | 8 | 8 |
| | | 40 | | |

Next, the remaining shares of the numbered lotto that do not match the actual lotto among the numbered lottos may be matched with other actual lotto through 1) a method of adding shares with non-numbered lotto shares; and 2) a method of adding the shares purchased by the seller. According to the method 1) above, the shares of the non-numbered lotto are consequently converted to the numbered lotto with the remaining shares that do not match the actual lotto.

The seller may selectively perform any one of the methods 1) and 2) above, but by performing the method 2) after performing the method 1), the cost of acquiring the actual lotto may be reduced.

Specifically, the remaining shares of the numbered lotto that do not match the actual lotto are combined with the shares of the non-numbered lotto and matched with other actual lottos, and as a result of the summation, the remaining shares that do not match other actual lottos are added to the shares purchased by the seller and matched with another actual lotto.

For example, as shown in Table 3, if there are numbered lottos, which consist of different numbers, of purchasers C, D, E, F, G, and H and non-numbered lottos of purchasers I and J that do not match the actual lotto, matching may be performed according to the matching methods 1 to 3.

TABLE 3
Example of summing shares of numbered lotto and non-
15 numbered lotto

| Purchaser | Lotto | | Shares | Remaining unmatched shares | | |
|---|---|---|---|---|---|---|
| | purchase | | purchase | Matching | Matching | Matching |
| | information | | information | method 1 | method 2 | method 3 |
| C | Numbered | 3, 21, 24, | 9 | 0 | 1 | 0 |
| | lotto | 38, 42, 44 | | | | |
| D | | 7, 13, 15, | 8 | 0 | 2 | 0 |
| | | 22, 30, 40 | | | | |
| E | | 1, 14, 17, | 8 | 0 | 2 | 0 |
| | | 23, 33, 43 | | | | |
| F | | 2, 9, 11, 23, | 7 | 0 | 0 | 0 |
| | | 31, 40 | | | | |
| G | | 8, 12, 19, | 6 | 0 | 0 | 2 |
| | | 20, 34, 42 | | | | |
| H | | 5, 15, 18, | 5 | 5 | 0 | 3 |
| | | 22, 38, 39 | | | | |
| I | Non- | — | 7 | — | — | — |
| J | numbered | — | 5 | — | — | — |
| | lotto | | | | | |

(Matching Method 1)

If the shares of non-numbered lotto are 2 or more, in matching method 1, shares of 2 or more are added to the numbered lotto shares in the order of the remaining number of shares.

Specifically, as shown in FIG. 2, after sorting (C-H) the numbered lotto in the order of the number of remaining shares that do not match the actual lotto, 7 and 5 shares of non-numbered lotto of purchasers I and J are summed in order.

According to the result of the summation by matching method 1, 5 actual lottos are matched, and 5 lotto shares of purchaser H that are not matched with actual lotto are combined with 5 shares purchased by the seller at their own expense, so that it is possible to match the purchasers' entire lotto with the actual lotto.

At this time, the purchaser I, who purchased non-numbered lotto, purchases 4 types of lotto with 7 shares, and the purchaser J purchases 2 types of lotto with 5 shares.

As matching method 1 adds up the remaining shares of the numbered lotto in descending order, compared to matching methods 2 and 3, the number of actual lotto matching increases, so that as the number of lottos purchased by sellers is reduced, the seller's burden of lotto management is reduced.

(Matching Method 2)

If the shares of non-numbered lotto are 2 or more, in matching method 2, shares of 2 or more are added to the numbered lotto shares in the order of the largest number of remaining shares.

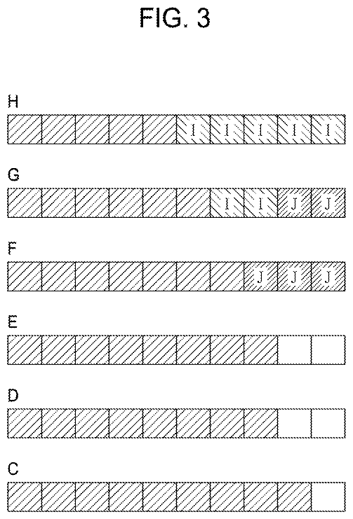

Specifically, as shown in FIG. 3, after sorting (H-C) the numbered lotto in the order of the largest number of remaining shares that do not match the actual lotto, 7 and 5 shares of non-numbered lotto of purchasers I and J are summed in order.

According to the result of the summation by matching method 2, 3 actual lottos are matched, and 2, 2, and 1 (total 5) lotto shares of purchasers E, D, and C that are not matched with actual lotto are combined with 5 shares purchased by the seller at their own expense, so that it is possible to match the purchasers' entire lotto with the actual lotto.

At this time, the purchaser I, who purchased non-numbered lotto, purchases 2 types of lotto with 7 shares, and the purchaser J purchases 2 types of lotto with 5 shares.

Matching method 2 has a relatively low winning probability of non-numbered lotto compared to matching methods 1 and 3, but the share ratio of lotto is high, so that if the lotto wins, it is possible to expect high winning money.

(Matching Method 3)

If the shares of the non-numbered lotto are 2 or more, matching method 3 adds each of the 2 or more shares with the shares of the numbered lottos with different numbers in sequence.

Specifically, after sorting the numbered lotto in the order in which the number of remaining shares that do not match the actual lotto is small or large, 7 and 5 shares of non-numbered lotto of purchasers I and J are summed one by one in order.

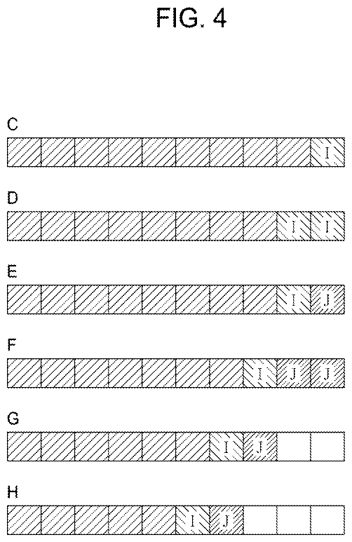

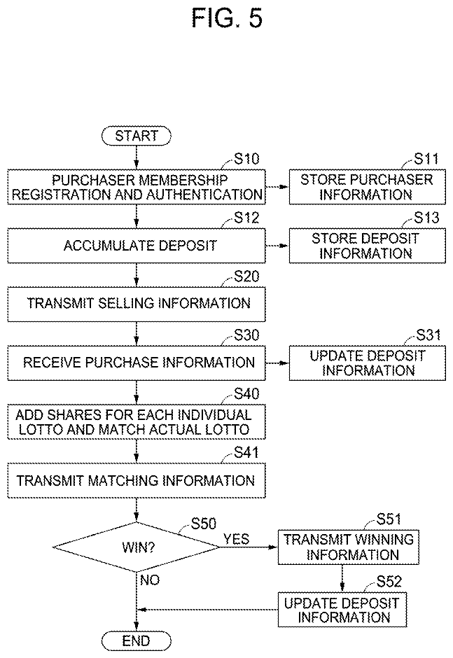

FIG. 4 shows a method in which the numbered lotto are sorted (C-H) in the order in which the remaining number of shares is small, and then the shares of the non-numbered lotto are added one by one in order.

At this time, if all the shares of the non-numbered lotto are filled one by one in the remaining shares of the numbered lotto and there are remaining shares, the remaining shares may be filled one by one into the remaining shares of the numbered lotto that do not match the actual lotto in the same way.

According to the result of the summation by matching method 3, 4 actual lottos are matched, and 2 and 3 (total 5) lotto shares of respective purchasers G and H that are not matched with actual lotto are combined with 5 shares purchased by the seller at their own expense, so that it is possible to match the purchasers' entire lotto with the actual lotto.

At this time, the purchaser I, who purchased non-numbered lotto, may purchase 6 types of lotto with 7 shares, and the purchaser J may purchases 4 types of lotto with 5 shares.

Compared to matching methods 1 and 2, in matching method 3, the types of lotto purchased by purchasers I and J who purchased non-numbered lotto are relatively increased. Therefore, matching method 3 has a higher winning probability of unspecified lotto than matching methods 1 and 2. In addition, matching method 3 allows shares of non-numbered lottos to be evenly distributed among lottos with different numbers, thereby reducing the variation in lotto winning probability.

In the matching method 3 described above, numbered lottos were sorted according to the remaining number of shares and then summed with non-numbered lottos, but regardless of the number of shares, it is possible to sort them in the order of purchase.

On the other hand, the remaining shares of non-numbered lotto that do not match other actual lotto among non-numbered lottos are added to the shares of different non-numbered lottos or added with the shares purchased by the seller to match another actual lotto.

This matching method may be applied when the total number of shares of the non-numbered lotto is greater than the total number of shares of the numbered lotto that is not matched with the actual lotto.

The lotto management unit 140 transmits matching information according to the above-described matching result to a plurality of purchaser terminals 10. Matching information includes photo information of the actual lotto including lotto number information and serial number information; and purchaser information and share information for corresponding lotto. Such matching information is stored in the database unit 160.

The winning management unit 160 transmits lotto lottery result information and winning money information according to the corresponding shares of the won lotto to the purchaser terminal 10. The cost processing unit updates the deposit information by adding winning money to the deposit. Here, the winning money is the amount excluding taxes and public charges, and a certain fee may be included according to the seller's policy.

The actual lotto withdrawal of winning money is possible after a certain period of time has elapsed from the date of the lottery, so that it is preferable to update the deposit after the date when the winning money may be withdrawn.

In the above, the one-time lotto purchase has been described, but according to the purchaser's selection, it may be configured to be purchased repeatedly in the same way every week.

Specifically, the purchase information management unit 130 may further receive repeat purchase information for purchasing the lotto of the next round from the purchaser terminal 10 under the same conditions as the purchase information of the current round.

The main configuration of the server 100 constituting the lotto ticket shares selling system of the present invention may include, as shown in FIG. 1, the cost processing unit 110, the selling information management unit 120, the purchase information management unit 130, the lotto management unit 140, and the winning management unit 150. Hereinafter, a method of selling lotto ticket shares using the main configuration will be described.

First, the server 100 receives the identity authentication signal along with the purchaser membership registration from the purchaser terminal 10 connected to the information and communications network 20 (S10), and stores the purchaser information in the database unit 160 (S11).

Thereafter, the cost processing unit 110 accumulates a deposit through the purchaser terminal 10 (S12), and stores the deposit information in the database unit 160 (S13).

The selling information management unit 120 transmits selling information to a plurality of purchaser terminals 10 (S20). Here, the selling information includes lotto selection information and shares selection information. In addition, if the purchaser wants to play the next lotto game in the same way as the current lotto game, it may further include repeat selection information that may be selected.

The purchase information management unit 130 receives purchase information corresponding to the selling information from the purchaser terminal 10 (S30). Here, the purchase information includes repeat purchase information corresponding to repeat selection information in addition to lotto purchase information and lotto shares information. At this time, the cost processing unit 110 updates the deposit information according to the purchase information (S31).

The lotto management unit 140 matches the actual lotto by adding up the shares for each lotto purchased by the purchaser or by adding the seller's shares according to the purchase information received from the purchase information management unit 130 (S40). Thereafter, the lotto management unit 140 transmits the matching information to the purchaser terminal 10 (S41).

The winning management unit 150 compares the lotto lottery result of the corresponding order with the actual lotto of the purchaser to determine whether to win (S50). The winning management unit 150 transmits the winning information to the purchaser terminal 10 when the actual lotto of the purchaser is won, and the cost processing unit 110 updates the deposit information by adding winning money excluding taxes and public charges from the deposit (S52).

It is apparent that the lotto ticket shares selling system of the present invention described above may be stored in a computer-readable recording medium in which a program for performing this is recorded and used.

In the above, the embodiment of the present invention has been mainly described, but it is obvious that the scope of the present invention extends to the technical ideas described in the claims and modifications or substitutions within the scope of equivalents thereto.

1. A lotto ticket shares selling system in which a server is connected to a plurality of purchaser terminals and information and communications networks that purchase divided shares of lotto, and a seller pays winning money of the lotto to a purchaser according to the shares,
wherein the server comprises:
a selling information management unit configured to transmit selling information including lotto selection information consisting of numbered lotto designated by a seller or a purchaser and unnumbered lotto and shares selection information divided for each selected lotto to the purchaser terminal;
a purchase information management unit configured to receive purchase information including lotto purchase information and shares purchase information selected by a purchaser with respect to the selling information from the plurality of purchaser terminals;
a lotto management unit configured to selectively combine a plurality of lottos included in the purchase information, and match the actual lotto according to a result of summing the combined plurality of lotto shares; and
a winning management unit configured to transmit lotto lottery result information and winning money information according to the corresponding shares of the won lotto to the plurality of purchaser terminals.

2. The lotto ticket shares selling system of claim 1, wherein if the lotto purchase information is a lotto designated by a purchaser among the numbered lottos, a purchase-possible minimum share rate is limited in the shares purchase information.

3. The lotto ticket shares selling system of claim 1, wherein the lotto management unit matches the actual lotto by summing shares for each lotto of the same number among the numbered lottos,
wherein the remaining shares of the numbered lotto that do not match the actual lotto are added to the shares of the non-numbered lotto or are added to the shares purchased by a seller to match other actual lotto.

4. The lotto ticket shares selling system of claim 3, wherein the remaining shares of the numbered lotto that do not match the actual lotto are combined with the shares of the non-numbered lotto to match other actual lotto, and the remaining shares that do not match the other actual lotto are added to the shares purchased by a seller and matched with another actual lotto according to a result of the summation.

5. The lotto ticket shares selling system of claim 3, wherein if the shares of the non-numbered lotto are 2 or more, the two or more shares are summed with the shares of the numbered lotto in the order in which the remaining number of shares is small or large.

6. The lotto ticket shares selling system of claim 3, wherein if the shares of the non-numbered lotto are 2 or more, each of the 2 or more shares is sequentially summed with the shares of the numbered lottos consisting of different numbers.

7. The lotto ticket shares selling system of claim 3, wherein among the non-numbered lottos, the remaining shares of the non-numbered lotto that do not match the other actual lotto are added to the shares of different non-numbered lottos or combined with the shares purchased by a seller to match another actual lotto.

8. The lotto ticket shares selling system of claim 1, wherein after the purchaser's lotto purchase, until a set time before the lottery, the lotto management unit transmits actual lotto information including serial number of the actual lotto matching each of the numbered lotto and the non-numbered lotto to the purchaser terminal.

9. The lotto ticket shares selling system of claim 1, wherein the purchase information management unit further receives repeat purchase information for purchasing lotto of the next round from the purchaser terminal under the same conditions as the purchase information.
